(19) United States
(12) Patent Application Publication
(10) Pub. No.: US 2017/0074678 A1
(43) Pub. Date: Mar. 16, 2017

(54) POSITIONING AND ORIENTATION DATA ANALYSIS SYSTEM AND METHOD THEREOF

(71) Applicant: GEOSAT Aerospace & Technology Inc., TAINAN CITY (TW)

(72) Inventors: CHENG-FANG LO, TAINAN CITY (TW); MENG-LUN TSAI, Tainan City (TW)

(21) Appl. No.: 15/261,177

(22) Filed: Sep. 9, 2016

(30) Foreign Application Priority Data
Sep. 11, 2015 (TW) 104130204

(51) Int. Cl. G01C 23/00; B64D 43/02; B64D 47/08; G01C 21/20; G01C 21/00

(52) U.S. Cl. CPC G01C 23/005; G01C 21/20; G01C 21/005; B64D 47/08; B64D 43/02

(57) ABSTRACT

A positioning and orientation data analysis system for air vehicles includes an image sensor module, a positioning and orientation module, and a processor module. The image sensor module captures a map image of a region and has an internal direction parameter. The positioning and orientation module generates a positioning and orientation external direction parameter from external satellite positioning information and navigation coordinate information that it tracks. The processor module, which is electrically coupled to the image sensor module and the positioning and orientation module, generates an image external direction parameter by using aerial triangulation of the map image; and then, by comparing this parameter with the positioning and orientation external direction parameter, generates a boresight angle parameter and a lever arm parameter. The processor module then generates a first geographic location coordinate from these last two parameters, the internal direction parameter and another positioning and orientation external direction parameter.

### CROSS-REFERENCE TO RELATED APPLICATION

This application claims the benefit of Taiwan Patent Application No. 104130204, filed on Sep. 11, 2015 in the Taiwan Intellectual Property Office, the disclosure of which is incorporated herein in its entirety by reference.

### BACKGROUND OF THE INVENTION

Field of the Invention

The present invention relates to a data analysis system and a data analysis method, and more particularly to the positioning and orientation data analysis system and method that use an integrated module for satellite positioning and inertial navigation to compute the map coordinate information from the map data.

Description of the Related Art

As space technology advances rapidly, various applications in remote sensing, navigation and telecommunications, with more specific examples being environmental change monitoring, disaster prevention, search and rescue, homeland security, resource exploration, and others, increasingly rely on the timely delivery of data. Therefore, the development of a fast and low-cost data capturing platform for the deployment of remote sensing technology, such as in surveying and cartography, is of great importance. In recent decades, airborne remote surveying has been employed extensively in high-precision mapping.

A direct geographic location system based on photography from an airborne platform, such as an airplane, is currently used as a sufficiently cost-effective and efficient mapping process. However, such aerial photography for direct geo-positioning still has certain limitations. Air vehicle rental for aerial photograph is costly, and the permit system is complicated and strictly regulated. This generally results in the possibility of only quick surveys with a limited ability to collect geographic location data.

In order to overcome the drawbacks of the conventional method of mapping of the prior art, the inventor of the present invention has designed and developed a positioning and orientation data analysis system and a method thereof.

### SUMMARY OF THE INVENTION

It is a primary objective of the present invention to overcome the drawbacks of the prior art by providing a positioning and orientation data analysis system and a method thereof.

To achieve the aforementioned and other objectives, a positioning and orientation data analysis system applied to an air vehicle is disclosed. The system includes at least one image sensor module, a positioning and orientation module, and a processor module. The at least one image sensor module captures a map image of a region, wherein the sensor module includes an internal direction parameter. The positioning and orientation module receives external satellite positioning information and tracks the displacement of the air vehicle to generate navigation coordinate information. It then generates a positioning and orientation external direction parameter from the external satellite positioning information and the navigation coordinate information. The processor module is electrically coupled to the at least one image sensor module and the positioning and orientation module, wherein the processor module is configured to receive the map image, and measure the map image to obtain an image external direction parameter. Then the processor module generates a boresight angle parameter and a lever arm parameter by comparing the image external direction parameter with the positioning and orientation external direction parameter. Then, when the positioning and orientation module obtains a next positioning and orientation external direction parameter, the processor module calculates and generates a first geographic location coordinate from the internal direction parameter, the boresight angle parameter, the lever arm parameter and the next positioning and orientation external direction parameter.

Preferably, the positioning and orientation module may include a satellite positioning unit, an inertial navigator and a filter. The satellite positioning unit receives the external satellite positioning information. The inertial navigator tracks the displacement of the air vehicle to generate the navigation coordinate information. The filter is electrically coupled to the satellite positioning unit and the inertial navigator, wherein the filter generates the positioning and orientation external direction parameter by calculating the external satellite positioning information and the navigation coordinate information using a filtering algorithm.

Preferably, the positioning and orientation module may further include a smoothing unit electrically coupled to the filter. The smoothing unit receives the positioning and orientation external direction parameter, and generates a positioning and orientation smoothing parameter by calculating the positioning and orientation external direction parameter using a smoothing algorithm.

Preferably, when the positioning and orientation module obtains the next positioning and orientation external direction parameter and the smoothing unit generates a next positioning and orientation smoothing parameter from the next positioning and orientation external direction parameter, then the processor module generates a second geographic location coordinate from the internal direction parameter, the boresight angle parameter, the lever arm parameter and the next positioning and orientation smoothing parameter.

Preferably, the navigation coordinate information may include position, speed, and attitude.

To achieve the aforementioned and other objectives, a positioning and orientation data analysis method applied to an air vehicle is disclosed. The method includes the following steps: capturing a map image of a region by at least one image sensor module, wherein the at least one image sensor module includes an internal direction parameter; receiving external satellite positioning information by a positioning and orientation module, wherein the positioning and orientation module tracks the displacement of the air vehicle to generate navigation coordinate information, and generates a positioning and orientation external direction parameter from the external satellite positioning information and the navigation coordinate information; receiving the map image by a processor module, wherein the processor module measures the map image to obtain an image external direction parameter, and generates a boresight angle parameter and a lever arm parameter from the image external direction parameter and the positioning and orientation external direction parameter; and obtaining a next positioning and orientation external direction parameter by the positioning and orientation module, wherein the processor generates a first geographic location coordinate from the internal direction parameter, the boresight angle parameter, the lever arm parameter and the next positioning and orientation external direction parameter.

Preferably, the step of generating the positioning and orientation external direction parameter may further include the following steps: receiving the external satellite positioning information by a satellite positioning unit; tracking the displacement of the air vehicle by an inertial navigator to generate the navigation coordinate information; and using a filtering algorithm to calculate and generate the positioning and orientation external direction parameter from the external satellite positioning information and the navigation coordinate information by a filter.

Preferably, the step of generating the positioning and orientation external direction parameter may further include the following steps: receiving the positioning and orientation external direction parameter by a smoothing unit. And then, generating a positioning and orientation smoothing parameter by calculating the positioning and orientation external direction parameter using a smoothing algorithm.

Preferably, the step of generating the positioning and orientation smoothing parameter may further include the following steps: obtaining the next positioning and orientation external direction parameter by the positioning and orientation module. Then, the smoothing unit generates another positioning and orientation smoothing parameter. And finally, the processor module generates a second geographic location coordinate from the internal direction parameter, the boresight angle parameter, the lever arm parameter and the other positioning and orientation smoothing parameter.

Preferably, the navigation coordinate information may include position, speed, and attitude.

To achieve the aforementioned and other objectives, a computer-implement method of positioning and orientation data analysis is disclosed. The computer-implement method includes the following steps: capturing a map image of a region, and providing an internal direction parameter therefrom; receiving external satellite positioning information, tracking a displacement of the air vehicle to generate navigation coordinate information, and generating a positioning and orientation external direction parameter from the external satellite positioning information and the navigation coordinate information; receiving the map image, measuring the map image to obtain an image external direction parameter, and generating a boresight angle parameter and a lever arm parameter from the image external direction parameter and the positioning and orientation external direction parameter; and obtaining a next positioning and orientation external direction parameter, and generating a first geographic location coordinate by calculating the internal direction parameter, the boresight angle parameter, the lever arm parameter and the next positioning and orientation external direction parameter, wherein the method is performed by a computing device.

Preferably, the external satellite positioning information is received by a satellite positioning unit and the navigation coordinate information is generated by tracking the displacement of the air vehicle using an inertial navigator, the satellite positioning unit and the inertial navigator are integrated as a tight coupling structure to generate the positioning and orientation external direction parameter.

Preferably, the step of generating the positioning and orientation external direction parameter may include: using a filtering algorithm to generate the positioning and orientation external direction parameter from the external satellite positioning information and the navigation coordinate information.

Preferably, the step of generating the positioning and orientation external direction parameter may include: receiving the positioning and orientation external direction parameter, and using a smoothing algorithm to generate a positioning and orientation smoothing parameter.

Preferably, the step of obtaining the next positioning and orientation external direction parameter may include: receiving the next positioning and orientation external direction parameter and generating a next positioning and orientation smoothing parameter, and calculating and generating a second geographic location coordinate from the internal direction parameter, the boresight angle parameter, the lever arm parameter and the next positioning and orientation smoothing parameter.

Preferably, the navigation coordinate information may include position, speed, and attitude.

In summary, the positioning and orientation data analysis system and method provide the satellite positioning unit, the inertial navigator and the filter of the position and orientation device for calculating the positioning and orientation external direction parameter. Besides, the boresight angle parameter and the lever arm parameter are obtained by the image external direction parameter. These last two parameters, along with the next positioning and orientation external direction parameter and an internal direction parameter of the at least one image sensor module are then used to calculate and generate an accurate first geographic location coordinate. The positioning and orientation data analysis system and method may be used together with a recording module to record the data and a processing module to process the data. The positioning and orientation data analysis system and method of the present invention is an integrated system that includes a multi-sensor system including a satellite positioning unit and an inertial navigator. The positioning and orientation data analysis system of the present invention overcomes the limitations of conventional measurements of the prior art by improving the ability to collect geographic location data in regions with few or no ground control points for aerial and satellite imagery. This improvement makes the collection of geographic location data more efficient and also lowers the cost significantly.

### BRIEF DESCRIPTION OF THE DRAWINGS

FIG. 1 is a block diagram of a positioning and orientation data analysis system in accordance with a first preferred embodiment of the present invention.

FIG. 2 is a schematic view of a map image of a positioning and orientation data analysis system in accordance with the first preferred embodiment of the present invention.

FIG. 3 is a block diagram of a positioning and orientation data analysis system in accordance with a second preferred embodiment of the present invention.

FIG. 4 is a flow chart of a positioning and orientation data analysis method in accordance with the first preferred embodiment of the present invention.

FIG. 5 is a flow chart of a positioning and orientation data analysis method in accordance with the second preferred embodiment of the present invention.

### DESCRIPTION OF THE PREFERRED EMBODIMENTS

In order to facilitate the understanding of the technical features, the contents and the advantages of the present invention, and the effectiveness thereof that can be achieved, the present invention will be illustrated in detail below through embodiments with reference to the accompanying drawings. On the other hand, the diagrams used herein are merely intended to be schematic and auxiliary to the specification, but are not necessary to be true scale and precise configuration after implementing the present invention. Thus, it should not be interpreted in accordance with the scale and the configuration of the accompanying drawings to limit the scope of the present invention on the practical implementation.

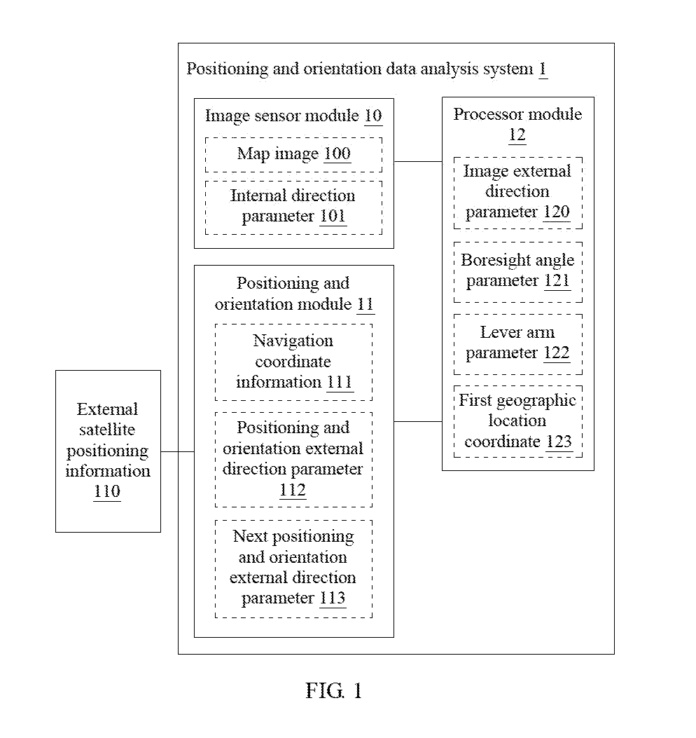

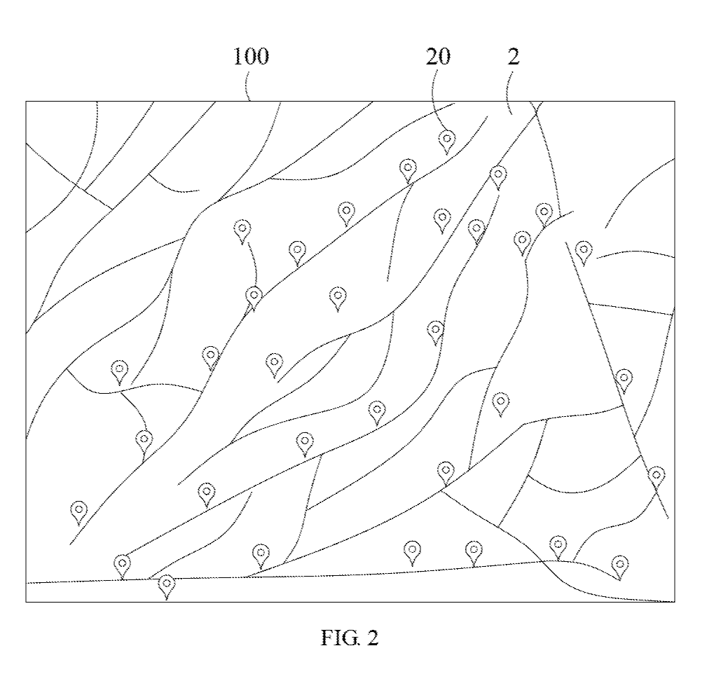

The following refers to FIGS. 1 and 2, that respectively show a block diagram of a positioning and orientation data analysis system and a schematic view of a map image, both in accordance with the first preferred embodiment of the present invention. The positioning and orientation data analysis system 1 may be applied to air vehicles, and the positioning and orientation data analysis system 1 includes at least one image sensor module 10, a positioning and orientation module 11 and a processor module 12. The at least one image sensor module 10 captures a map image 100 of a region, and the at least one image sensor module 10 includes an internal direction parameter 101. The positioning and orientation module 11 receives external satellite positioning information 110, tracks a displacement of the air vehicle to generate navigation coordinate information 111 and generates a positioning and orientation external direction parameter 112 from the external satellite positioning information 110 and the navigation coordinate information 111. The processor module 12 is electrically coupled to the at least one image sensor module 10 and the positioning and orientation module 11, receives the map image 100, then generates an image external direction parameter 120 from the map image 100, and then generates a boresight angle parameter 121 and a lever arm parameter 122 by comparing the image external direction parameter 120 with the positioning and orientation external direction parameter 112. Then, when the positioning and orientation module 11 obtains a next positioning and orientation external direction parameter 113, the processor module 12 calculates and generates a first geographic location coordinate 123 from the internal direction parameter 101, the boresight angle parameter 121, the lever arm parameter 122, and the other positioning and orientation external direction parameter 113.

Specifically, the positioning and orientation data analysis system 1 of the present invention is applied to an air vehicle (such as an airplane or an unmanned aerial vehicle, etc.), wherein the system 1 is installed in the air vehicle and provided for aerial photography or airborne remote sensing measurements. The positioning and orientation data analysis system 1 includes at least one image sensor module 10, a positioning and orientation module 11, and a processor module 12. The at least one image sensor module 10 is a digital camera and has an internal direction parameter 101 (such as a focal length, a primary pixel, or a lens distortion mode of the at least one image sensor 10), and the at least one image sensor module 10 may be used to automatically correct systematic errors in 3D coordinate measurements. The at least one image sensor module 10 captures a map image 100 of at least one region 2 and calibrates a plurality of region control points 20. The region control points 20 are uniformly distributed in a calibrated area of the region 2. The processor module 12 uses a global navigation satellite system (GNSS) to control network adjustment to calculate the coordinates of each region control point 20, and then, by carrying out aerial triangulation of the plurality of region control points 20, calculates and generates an image external direction parameter 120 from the map image 100.

The positioning and orientation module 11 receives the external satellite positioning information 110, which includes the satellite positioning time, transmitted from the external satellite device, tracks a displacement of the air vehicle to generate navigation coordinate information 111, and then generates a positioning and orientation external direction parameter 112 from the external satellite positioning information 110 and the navigation coordinate information 111. Then the processor module 12 compares the image external direction parameter 120 with the positioning and orientation external direction parameter 112 to generate a boresight angle parameter 121 and a lever arm parameter 122.

After these parameters are generated, the positioning and orientation data analysis system 1 may use the positioning and orientation module 11 to generate a next positioning and orientation external direction parameter 113 on a later day in which the air vehicle takes another flight route and captures another map image 100. The processor module 12 then calculates the internal direction parameter 101, the boresight angle parameter 121, the lever arm parameter 122 and the next positioning and orientation external direction parameter 113 to generate a direct geographic location result corresponding to the other map image 100. The result is first geographic location coordinate 123.

After the air vehicle has carried out the desired aerial photography or airborne remote sensing measurements, the next positioning and orientation external direction parameter 113 is integrated and calculated with the internal direction parameter 101, the boresight angle parameter 121, and the lever arm parameter 122. The positioning and orientation module 11 is then able to derive an external direction parameter for another map image 100 without requiring a further use of aerial triangulation. In other words, the geographic location result is obtained directly and is then made available for further precision analysis.

In addition, the positioning and orientation data analysis system 1 of the present invention further includes a recording module to record the aforementioned information such as the map image 100, the internal direction parameter 101, the external satellite positioning information 110, the navigation coordinate information 111, the positioning and orientation external direction parameter 112, the image external direction parameter 120, the boresight angle parameter 121, the lever arm parameter 122, the next positioning and orientation external direction parameter 113, and the first geographic location coordinate 123.

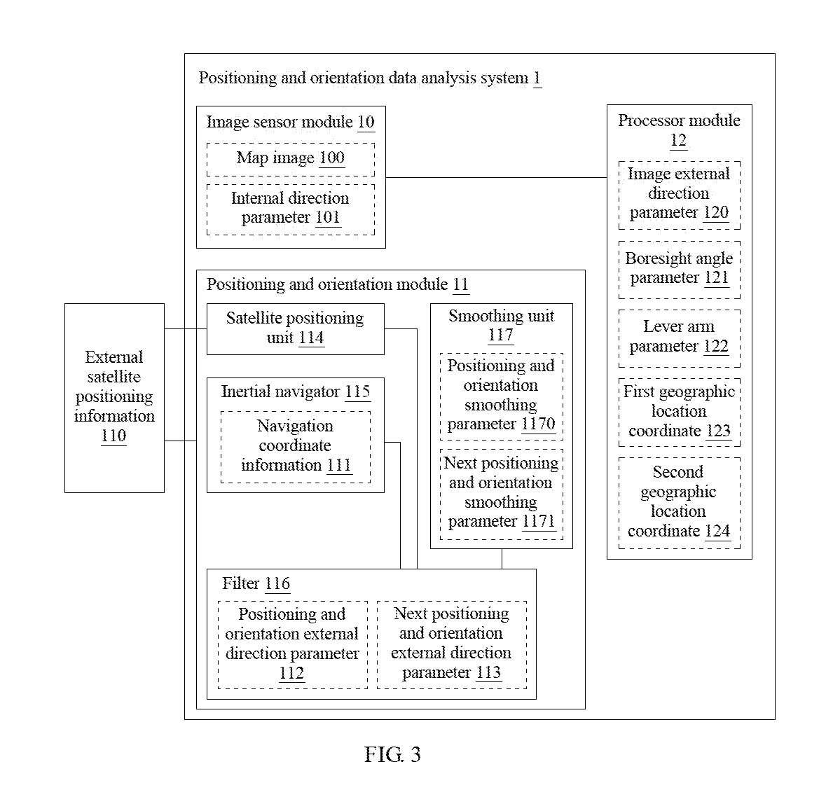

The following refers to FIG. 3, a block diagram of a positioning and orientation data analysis system in accordance with the second preferred embodiment of the present invention, as well as to FIGS. 1 and 2. The positioning and orientation data analysis system of this embodiment is substantially the same as that of the first preferred embodiment except that the positioning and orientation module 11 of this preferred embodiment further includes a satellite positioning unit 114, an inertial navigator 115 and a filter 116. The satellite positioning unit 114 receives the external satellite positioning information 110. The inertial navigator 115 tracks a displacement of the air vehicle to generate navigation coordinate information 111. The filter 116, which is electrically coupled to the satellite positioning unit 114 and the inertial navigator 115, calculates and generates a positioning and orientation external direction parameter 112 from the external satellite positioning information 110 and the navigation coordinate information 111 by using a filtering algorithm.

The following describes an example implementation of this embodiment. The positioning and orientation module 11 of the present invention further includes a satellite positioning unit 114, an inertial navigator 115 and a filter 116. The satellite positioning unit 114 may be a global navigation satellite system (GNSS) that receives the external satellite positioning information 110 transmitted from the external satellite device. The inertial navigator 115 may be an inertial navigation system (INS) that tracks a flight displacement of the air vehicle to generate navigation coordinate information 111 such as position, speed, attitude, etc. The filter 116 may be an integrated Kalman filter that receives the external satellite positioning information 110 and the navigation coordinate information 111 and then calculates and generates a positioning and orientation external direction parameter 112 by using a filtering algorithm.

The satellite positioning unit 114 and the inertial navigator 115 is generally integrated as a loose coupling structure or a tight coupling structure. Their operation includes the steps of: outputting a difference in the positions measured and a difference in the speeds measured by the satellite positioning unit 114 and the inertial navigator 115. These values are then inputted into the filter 116 to estimate the error of the inertial navigator 115. The error is then feed back to the inertial navigator 115 in order to correct the position, speed and attitude readings. This feedback primarily corrects deviations due to the error in the detected acceleration and due to the gyroscopic drift of the inertial navigator 115. The loose coupling structure treats the satellite positioning unit 114 and the inertial navigator 115 as two independent systems. For the satellite positioning unit 114 to generate a positioning reading, it has to receive more than four external satellite signals simultaneously. In certain situations, when the satellite positioning unit 114 is situated in an area, such as among tall buildings, in tunnels, green tunnels, or in other places where satellite signals may be blocked, there may be a failure to receive four or more satellite signals and therefore in such a case the satellite positioning unit 114 will be unable to generate the positioning reading.

Due to this limitation, the positioning and orientation module 11 of the present invention adopts the tight coupling structure form of integrating the satellite positioning unit 114 and the inertial navigator 115. In the tight coupling structure form of integration, the two units are treated as the same system. They are used together to generate the positioning reading, such that if the signal received by the satellite positioning unit 114 is weak, the positioning and orientation module 11 will manage with a normal external satellite signal from one satellite only to generate the positioning reading.

The following describes how the filter 116 of the present invention uses a filtering algorithm to calculate the positioning and orientation external direction parameter 112. The basic algorithm used by the inertial navigator 115 of the present invention to generate the navigation coordinate information 111 of an air vehicle uses a navigation equation, which is a mechanization equation that integrates the angular speed and the acceleration detected by a gyroscope and an accelerometer to obtain the position, speed, and attitude readings of the air vehicle. The Earth's rotation and gravitational acceleration must be taken into account in the calculation process as shown in equations (1) and (2):

$$\begin{matrix}[ \begin{matrix}{\dot{r}}^{1} \\ {\dot{v}}^{1} \\ {\dot{R}}_{b}^{1}\end{matrix} ] = [ \begin{matrix}{D}^{- 1} {v}^{1} \\ {R}_{b}^{1} {f}^{b} - ( 2 {Ω}_{ie}^{1} + {Ω}_{e 1}^{1} ) {v}^{1} + {g}^{1} \\ {R}_{b}^{1} ( {Ω}_{ib}^{b} - {Ω}_{i 1}^{b} )\end{matrix} ] & ( 1 ) \\ {D}^{- 1} = [ \begin{matrix}0 & \frac{1}{M + h} & 0 \\ \frac{1}{( N + h ) cos φ} & 0 & 0 \\ 0 & 0 & 1\end{matrix} ] & ( 2 )\end{matrix}$$

Where r¹ refers to the position vector of a horizontal coordinate system (l-frame) in a region where the air vehicle is situated; v¹ refers to an l-frame speed vector vₑₐₛₜ (pointing east), vₙₒᵣₜₕ (pointing north), and vᵤₚ (pointing up); R_{b}¹ refers to the rotation matrix between the position and attitude (b-frame) of the entire carrier of the inertial navigator 115 of the air vehicle and the l-frame, which is formed by the values of the trigonometric functions of three attitude angles; gl is the gravitational acceleration vector with respect to the l-frame; Ω_{ib}^{b} and Ωᵢₗ^{b} are antisymmetric matrices of the angular speed vectors ωᵢₗ^{b} and ωᵢₗ^{b} respectively; and M and N are the radii of curvature of the meridian and the prime vertical respectively.

The error due to the inertial navigator 115 is corrected, before further improvements in the accuracy of the positioning reading are made. This error can be corrected by using a dynamic error model and a filter 116. The dynamic error model uses a linearized equation to describe the inertial navigator 115 and omits high-order terms. The errors in the positioning reading are the errors in a total of nine elements including the three position, three speed, and three attitude components. The errors of the inertial navigator 115 include the deviation in the three acceleration components and the drift in the three gyroscopic components. An error state vector with all 15 parameters is formed, and the dynamic error model is expressed by equation (4) below:

\dot{x}=Fx+Gw (4)

Wherein, X is the state vector of the satellite positioning and inertial navigation errors with a total of 15 elements [δφ, δλ, δh, δv_{N}, δv_{E}, δv_{D}, δp, δr, δA, δwₓ, δw_{y}, δSw_{z}, δf_{y}, δf_{z}]; F is a dynamic matrix; and G is the noise of the positioning and orientation module 11.

The observed quantity update model is illustrated by equation (5) below:

Z=Hx+v (5)

Wherein, X is the state vector as in equation 4; H is a dynamic matrix; and v is the noise of the observed quantity.

The filter 116 estimates these parameters through feedback, and the equations of the filter 116 are divided into two types: prediction and update. The prediction equations use the state of a time period to derive the state of the next time period as shown in equations (6) and (7) below:

\hat{x}ₖ(−)=Φₖ\hat{x}ₖ₋₁(+) (6)

P(−)=ΦₖPₖ₋₁(+)φₖ^{T}+Qₖ₋₁ (7)

Wherein, P is the estimated value of the variance-covariance matrix of the state error; Q is a system error matrix; (−) stands for the estimated value after die prediction; and (+) stands for the estimated value after the update.

The update equations are used to obtain the best state estimated value for the next time period from the state of a new observed quantity at a previous time period, and the update equations are the equations (8), (9) and (10) below:

Kₖ=Pₖ(−)Hₖ^{T}[HₖPₖ(−)Hₖ^{T}+Rₖ]⁻¹ (8)

\hat{x}ₖ(+)=\hat{x}ₖ(−)+Kₖ(Zₖ−Hₖ\hat{x}ₖ(−)) (9)

Pₖ(+)=Pₖ(−)−KₖHₖ^{T}Pₖ(−) (10)

Wherein, K is a Kalman gain matrix; Z is an update vector of the observed quantities (position and speed); and R is the variance-covariance matrix of the observed quantity.

A conventional Kalman filter has some insurmountable limitations and these limitations will cause the positioning errors to accumulate when the integrated positioning system receives no satellite signals. In practice, the errors in the composite GNSS/INS navigation readings are solved primarily by using the Kalman filtering algorithm in a post-processing technique to improve the positioning precision of the integrated system. This involves the use of a smoothing unit 117, such as a smoother, which is a non-real time estimator.

The positioning and orientation module 11 of the present invention further includes a smoothing unit 117 that is electrically coupled to the filter 116. The smoothing unit 117 receives a positioning and orientation external direction parameter 112, and then calculates the positioning and orientation external direction parameter 112 by using a smoothing algorithm, so as to generate a positioning and orientation smoothing parameter 1170. On a later day when the air vehicle takes another flight route and captures another map image 100, the positioning and orientation module 11 generates a next positioning and orientation external direction parameter 113, and uses the smoothing unit 117 to generate a next positioning and orientation smoothing parameter 1171 from the other positioning and orientation external direction parameter 113. The processor module 12 calculates and generates a second geographic location coordinate 124, which corresponds to the other map image 100, from the internal direction parameter 101, the boresight angle parameter 121, the lever arm parameter 122, and the next positioning and orientation smoothing parameter 1171.

Furthermore, the smoothing unit 117 of the present invention carries out the post-processing after the filter 116 carries out the filtering process. The smoothing unit 117 uses all of the past, present, and future observed quantities to find an ideal estimated solution, and all smoothing computations are based on all filtering solutions. Therefore, a good filtering solution will lead to a good smoothing solution. The present invention adopts the fixed-interval smoothing method with the intention of obtaining the best position information from all observation points. However, a further use of the post-processing method is required to achieve said goal.

In general, the smoothing unit 117 includes a forward filtering solution and a backward filtering solution. Compared with other fixed-interval smoothers, the backward smoothing algorithm (Rauch-Tung-Striebel, RTS) is the simplest and easiest to use. The RTS smoother is combined with a forward sweep and a backward sweep. The forward sweep is used to obtain all predictions and update estimates of the filter 116 that correspond to the covariance matrix of every time period. The backward sweep is started at the end point of the forward filtering of the forward filter (such as at the time period N), with the initial condition of \hat{x}_{N,N}^{s}=\hat{x}_{N,N}; and P_{N,N}^{s}=P_{N,N}. The RTS smoothing algorithm is shown in equations (11) and (12) below:

\hat{x}_{k,N}^{s}=\hat{x}_{k,k}+Aₖ(\hat{x}_{k+1,N}^{s}−\hat{x}_{k+1,k}) (11)

Aₖ=P_{k,k}Φ_{k+1,k}^{T}P_{k+1,k}⁻¹ (12)

Wherein, \hat{x}_{k,N}^{s} is the smoothing estimate of the state vector; Aₖ is the smoothing gain matrix, and k=N−1, N−2, . . . , 0.

The covariance matrix of a smooth state of the smoothing unit 117 of the present invention is given in equation (13) below:

P_{k,N}^{s}=P_{k,k}+Aₖ(P_{k+1,N}^{s}−P_{k+1,k})Aₖ^{T} (13)

The observed quantities of the positioning and orientation data analysis system 1 of the present invention from time 0 to N can be obtained in a single flight. The filter 116 estimates the filtering solution for every time period k(\hat{x}_{k,N}^{s}), where k=0, 1, 2 . . . N. In the fixed-interval smoothing algorithm, the initial and final time of all regions of the observed quantity are fixed, such as at 0 and N. Now, the required result is to have ideal smoothing estimated solutions in all time periods k. In this algorithm, the updates of all observed quantities from 0 to N are used, so that the ideal smoothing estimate at the time period k is \hat{x}_{k,k}^{s}. In smoothing algorithms of this sort, all observed quantities from 0 to N are required, which implies that such smoothing algorithms can only be used in post-processing. The RTS smoothing estimate at any time period k is obtained from a linear combination of the filtering estimate of the time period k and the smoothing estimate at the time period k+1, so that the RTS smoothing estimate can be used to update a forward filtering solution and thus obtain an improved estimated solution. For every time period of used to compute the smoothing estimate, it is necessary to store the prediction estimate, the update estimate, and the corresponding covariance matrix of the filter 116 of each time period. In other words, continuous acquisition of data is not interrupted while processing the integrated solution of the satellite positioning unit 114 and the inertial navigator 115. If a shadowing effect occurs in the satellite positioning unit 114, then only the prediction state and the covariance matrix can be obtained.

In addition, the positioning and orientation data analysis system 1 of the present invention adds geographic location to the map image 100 directly by obtaining the geospatial coordinates with equation (3) as follows.

rᵢ^{m}=r(t)ₙₐᵥ^{m}+R(t)_{b}^{m}(sᵢR_{c}^{b}rᵢ^{c}+r_{INS}^{c}−r_{INS}^{GNSS}) (3)

Wherein, rᵢ^{m} is the coordinate of a measuring point i on an object space; rₙₐᵥ^{m}(t) is the coordinate that integrates a positioning and orientation system on an object space; Si is a scaling factor; R(t)_{b}^{m} is a between the inertial navigator 115 and the object space coordinate system; t is a shutter time; R_{c}^{b} is the rotation matrix of the coordinate system of the image sensor module 10 and the inertial navigator 115, which is called a boresight angle; rᵢ^{c} is the position of a measuring point in the coordinate system of the image sensor module 10, which is also the coordinate of the map image 100; r_{INS}^{c} is a position vector of the coordinate system of the inertial navigator 115 and the image sensor module 10, which is called a lever arm; r_{INS}^{GNSS} is a position vector difference of the inertial navigator 115 and the antenna of the satellite positioning unit 114.

In the aforementioned description of the positioning and orientation data analysis system of the present invention, the method thereof has also been illustrated. For convenience, the following flow charts of two preferred embodiments of the method of the present invention are also provided.

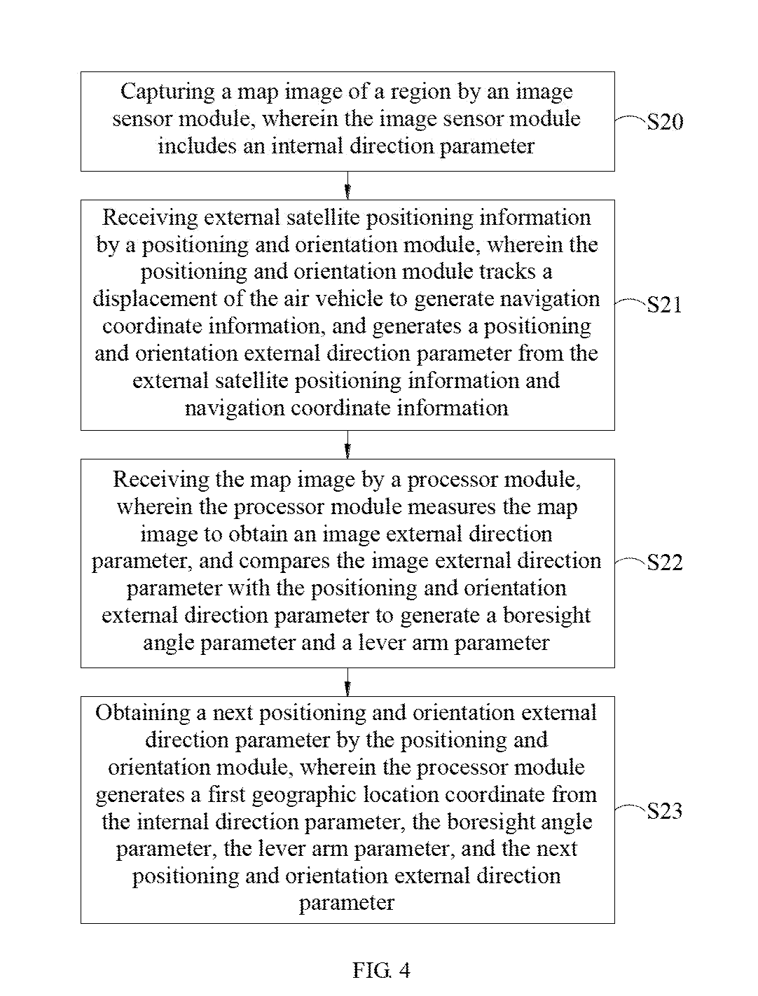

The following refers to FIGS. 1 to 3, and replicates the steps shown in the flow chart of FIG. 4 of a positioning and orientation data analysis method in accordance with the first preferred embodiment of the present invention. The positioning and orientation data analysis method of this preferred embodiment includes the following steps:

S20: Capturing a map image of a region by at least one image sensor module, wherein the at least one image sensor module includes an internal direction parameter.

S21: Receiving external satellite positioning information by a positioning and orientation module, wherein the positioning and orientation module tracks a displacement of the air vehicle to generate navigation coordinate information, and generates a positioning and orientation external direction parameter from the external satellite positioning information and navigation coordinate information.

S22: Receiving the map image by a processor module, wherein the processor module measures the map image to obtain an image external direction parameter, and compares the image external direction parameter with the positioning and orientation external direction parameter to generate a boresight angle parameter and a lever arm parameter.

S23: Obtaining a next positioning and orientation external direction parameter by the positioning and orientation module, wherein the processor module generates a first geographic location coordinate from the internal direction parameter, the boresight angle parameter, the lever arm parameter, and the next positioning and orientation external direction parameter.

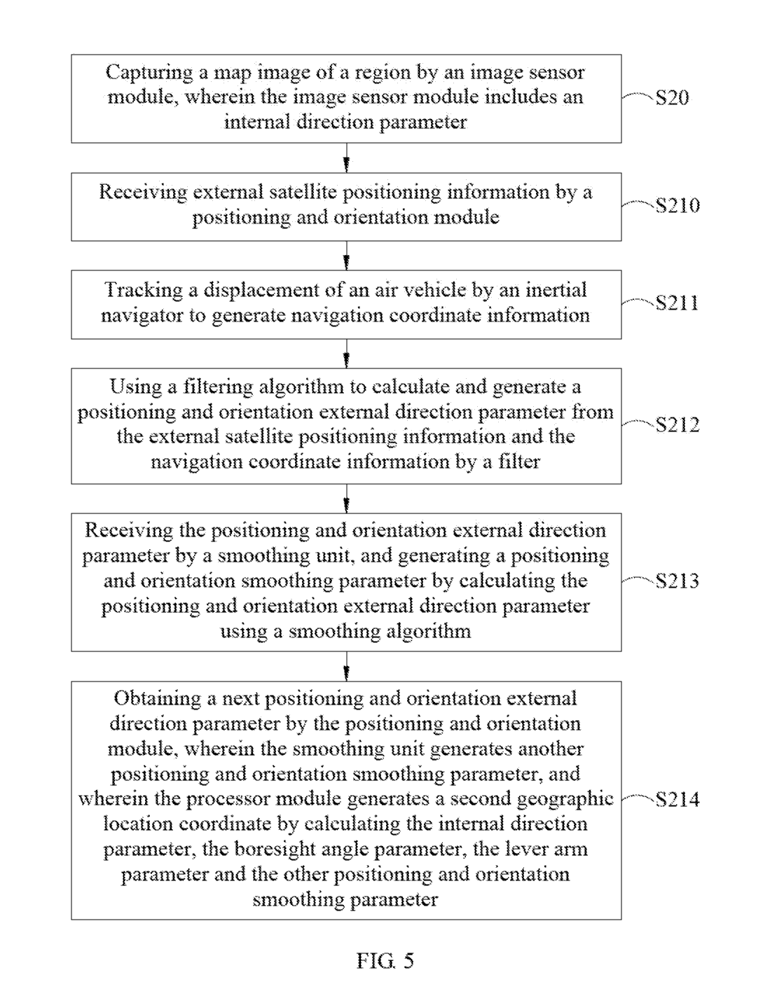

The following refers to FIGS. 1 to 4, and replicates in part the steps shown in the flow chart of FIG. 5 of a positioning and orientation data analysis method in accordance with the second preferred embodiment of the present invention. The positioning and orientation data analysis method of this preferred embodiment further includes the following steps in the step S21:

S210: Receiving external satellite positioning information by a positioning and orientation module.

S211: Tracking a displacement of an air vehicle by an inertial navigator to generate navigation coordinate information.

S212: Using a filtering algorithm to calculate and generate a positioning and orientation external direction parameter from the external satellite positioning information and the navigation coordinate information by a filter.

Then, the positioning and orientation data analysis method of the second preferred embodiment of the present invention preferably includes the following steps after the step S212 of generating the positioning and orientation external direction parameter:

S213: Receiving the positioning and orientation external direction parameter by a smoothing unit, and generating the positioning and orientation smoothing parameter by calculating the positioning and orientation external direction parameter using a smoothing algorithm.

Then, the positioning and orientation data analysis method of the second preferred embodiment of the present invention further includes the following steps after the step S213 of generating the positioning and orientation smoothing parameter:

S214: Obtaining a next positioning and orientation external direction parameter by the positioning and orientation module, wherein the smoothing unit generates another positioning and orientation smoothing parameter, and wherein the processor module generates a second geographic location coordinate by calculating the internal direction parameter, the boresight angle parameter, the lever arm parameter and the next positioning and orientation smoothing parameter.

The invention of this disclosure has been described by means of specific embodiments. The above description is only illustrative, but is not restrictive. However, numerous modifications and variations can be made thereto by those skilled in the art without departing from the scope and spirit of the invention set forth in the claims.

1. A positioning and orientation data analysis system, applied to an air vehicle, comprising:
at least one image sensor module configured to capture a map image of a region, wherein the at least one image sensor module comprises an internal direction parameter;
a positioning and orientation module configured to:
receive external satellite positioning information;
track a displacement of the air vehicle to generate navigation coordinate information; and
generate a positioning and orientation external direction parameter from the external satellite positioning information and the navigation coordinate information; and
a processor module electrically coupled to the at least one image sensor module and the positioning and orientation module, wherein the processor module is configured to:
receive the map image;
measure the map image to obtain an image external direction parameter; and
generate a boresight angle parameter and a lever arm parameter by comparing the image external direction parameter and the positioning and orientation external direction parameter;
wherein when the positioning and orientation module obtains a next positioning and orientation external direction parameter, the processor module calculates and generates a first geographic location coordinate from the internal direction parameter, the boresight angle parameter, the lever arm parameter and the next positioning and orientation external direction parameter.

2. The positioning and orientation data analysis system of claim 1, wherein the positioning and orientation module comprises:
a satellite positioning unit configured to receive the external satellite positioning information;
an inertial navigator configured to track the displacement of the air vehicle to generate the navigation coordinate information; and
a filter, electrically coupled to the satellite positioning unit and the inertial navigator, wherein the filter is configured to generate the positioning and orientation external direction parameter by calculating the external satellite positioning information and the navigation coordinate information using a filtering algorithm.

3. The positioning and orientation data analysis system of claim 2, wherein the positioning and orientation module further comprises:
a smoothing unit electrically coupled to the filter, wherein the smoothing unit is configured to:
receive the positioning and orientation external direction parameter, and
generate a positioning and orientation smoothing parameter by calculating the positioning and orientation external direction parameter using a smoothing algorithm.

4. The positioning and orientation data analysis system of claim 3, wherein when the positioning and orientation module obtains the next positioning and orientation external direction parameter and the smoothing unit generates a next positioning and orientation smoothing parameter from the next positioning and orientation external direction parameter, the processor module generates a second geographic location coordinate from the internal direction parameter, the boresight angle parameter, the lever arm parameter and the next positioning and orientation smoothing parameter.

5. The positioning and orientation data analysis system of claim 1, wherein the navigation coordinate information includes position, speed, and attitude.

6. A positioning and orientation data analysis method applying to an air vehicle, comprising the steps of:
capturing a map image of a region by at least one image sensor module, wherein the at least one image sensor module comprises an internal direction parameter;
receiving external satellite positioning information by a positioning and orientation module; wherein the positioning and orientation module tracks a displacement of the air vehicle to generate navigation coordinate information, and generates a positioning and orientation external direction parameter from the external satellite positioning information and the navigation coordinate information;
receiving the map image by a processor module, wherein the processor module measures the map image to obtain an image external direction parameter, and generates a boresight angle parameter and a lever arm parameter from the image external direction parameter and the positioning and orientation external direction parameter; and
obtaining a next positioning and orientation external direction parameter by the positioning and orientation module, and wherein the processor module generates a first geographic location coordinate from the internal direction parameter, the boresight angle parameter, the lever arm parameter and the next positioning and orientation external direction parameter.

7. The positioning and orientation data analysis method of claim 6, wherein the step of generating the positioning and orientation external direction parameter further comprises the steps of:
receiving the external satellite positioning information by a satellite positioning unit;
tracking the displacement of the air vehicle to generate the navigation coordinate information by an inertial navigator; and
using a filtering algorithm to calculate and generate the positioning and orientation external direction parameter from the external satellite positioning information and the navigation coordinate information by a filter.

8. The positioning and orientation data analysis method of claim 7, wherein the step of generating the positioning and orientation external direction parameter further comprises the steps of:
receiving the positioning and orientation external direction parameter by a smoothing unit, and generating a positioning and orientation smoothing parameter by calculating the positioning and orientation external direction parameter using a smoothing algorithm.

9. The positioning and orientation data analysis method of claim 8, wherein the step of generating the positioning and orientation smoothing parameter further comprises the steps of:
obtaining the next positioning and orientation external direction parameter by the positioning and orientation module; wherein the smoothing unit generates another positioning and orientation smoothing parameter, and wherein the processor module generates a second geographic location coordinate by calculating the internal direction parameter, the boresight angle parameter, the lever arm parameter and the other positioning and orientation smoothing parameter.

10. The positioning and orientation data analysis method of claim 6, wherein the navigation coordinate information includes position, speed, and attitude.

11. A computer-implement method of positioning and orientation data analysis, comprising the steps of:
capturing a map image of a region and providing an internal direction parameter therefrom;
receiving external satellite positioning information, tracking a displacement of the air vehicle to generate navigation coordinate information, and generating a positioning and orientation external direction parameter from the external satellite positioning information and the navigation coordinate information;
receiving the map image, measuring the map image to obtain an image external direction parameter, and generating a boresight angle parameter and a lever arm parameter from the image external direction parameter and the positioning and orientation external direction parameter; and
obtaining a next positioning and orientation external direction parameter, and generating a first geographic location coordinate by calculating the internal direction parameter, the boresight angle parameter, the lever arm parameter and the next positioning and orientation external direction parameter;
wherein the method is performed by a computing device.

12. The computer-implement method of positioning and orientation data analysis of claim 11, wherein the external satellite positioning information is received by a satellite positioning unit and the navigation coordinate information is generated by tracking the displacement of the air vehicle using an inertial navigator, the satellite positioning unit and the inertial navigator are integrated as a tight coupling structure to generate the positioning and orientation external direction parameter.

13. The computer-implement method of positioning and orientation data analysis of claim 11, wherein generating the positioning and orientation external direction parameter comprises:
using a filtering algorithm to generate the positioning and orientation external direction parameter from the external satellite positioning information and the navigation coordinate information.

14. The computer-implement method of positioning and orientation data analysis of claim 11, wherein generating the positioning and orientation external direction parameter comprises:
receiving the positioning and orientation external direction parameter, and using a smoothing algorithm to generate a positioning and orientation smoothing parameter.

15. The computer-implement method of positioning and orientation data analysis of claim 14, wherein obtaining the next positioning and orientation external direction parameter comprises:
receiving the next positioning and orientation external direction parameter and generating a next positioning and orientation smoothing parameter, and generating a second geographic location coordinate from the internal direction parameter, the boresight angle parameter, the lever arm parameter and the next positioning and orientation smoothing parameter.

16. The computer-implement method of positioning and orientation data analysis of claim 11, wherein the navigation coordinate information includes position, speed, and attitude.
